(19) United States
(12) Patent Application Publication
(10) Pub. No.: US 2019/0187029 A1
(43) Pub. Date: Jun. 20, 2019

(54) TIRE-MOUNTED SENSOR AND CHAIN REGULATION MANAGEMENT SYSTEM

(71) Applicant: DENSO CORPORATION, Kariya-city, Aichi-pref. (JP)

(72) Inventors: Ryosuke KANBAYASHI, Kariya-city (JP); Takatoshi SEKIZAWA, Kariya-city (JP); Masashi MORI, Kariya-city (JP)

(21) Appl. No.: 16/322,166

(22) PCT Filed: Jun. 23, 2017
(86) PCT No.: PCT/JP2017/023196

§ 371 Date: Jan. 31, 2019

(30) Foreign Application Priority Data
Aug. 5, 2016 (JP) 2016-154755
Jun. 12, 2017 (JP) 2017-115277

(51) Int. Cl. G01M 17/02; B60C 27/00

(52) U.S. Cl. CPC G01M 17/025; B60C 27/00

(57) ABSTRACT

A tire-mounted sensor is provided to check whether a chain is attached or not so that a monitor person manages a chain regulation based on a check result. Specifically, a communication center is notified of a vehicle in violation which is not in compliance with the chain regulation. Based on violation information which is communicated to the communication center, the monitor person easily identifies the vehicle which is in violation. In addition, whether the chain regulation is complied with or violated is stored in a memory circuit unit of the tire-mounted sensor as tire state data. When the monitor person sends an instruction command by using a tool, the tire state data is transmitted from the tire-mounted sensor to the tool. It is thus made possible for the monitor person to confirm whether the vehicle is in violation or not by simply referring to the tool.

### CROSS REFERENCE TO RELATED APPLICATION

This application is based on Japanese patent application No. 2016-154755 filed on Aug. 5, 2016 and Japanese patent application No. 2017-115277 filed on Jun. 12, 2017, the entire contents of which are incorporated herein by reference.

### TECHNICAL FIELD

The present disclosure relates to a tire-mounted sensor and a chain regulation management system which enable confirmation that a chain is attached to a tire or a vehicle is in compliance with a so-called chain regulation, that is, winter tire regulation about using a studless tire.

### BACKGROUND ART

For ensuring traveling safety of a vehicle on a snow-covered road and the like, a chain regulation is enforced. The chain regulation is enforced by a monitor person, who visually checks a tire whether a chain is attached to a tire or a vehicle uses a studless tire which is a winter tire. However, it is difficult to check whether or not the chain is attached to the tire or whether the vehicle uses the studless tire unless the monitor person stops a traveling vehicle and visually checks the tire. Particularly, in such a situation that the tire is covered with snow because of traveling on a snow-covered road, it is often not possible to check instantly whether the chain is attached to the tire or the vehicle uses the studless tire. For this reason, it is a troublesome work to confirm that the vehicle is in compliance with the chain regulation.

For example, patent document 1 discloses a device which is capable of determining that the chain is attached to the tire. In case that a chain is attached to a driving wheel, which is one of a front wheel and a rear wheel, strain gauges arranged on rear surfaces of treads of tires generate different output values between the front wheel and the rear wheel. For this reason, the device determines that the chain is attached when an output difference is equal to or larger than a threshold value.

### PRIOR ART LITERATURE

### Patent Literature

Patent literature: JP 2007-118685A

### SUMMARY OF INVENTION

However, according to the device described in patent document 1, it is only possible to detect that the chain is attached to the tire. It is impossible to reduce a workload of a monitor person in checking whether the vehicle is in compliance with the chain regulation. Further, it is not possible to detect that the chain is attached unless the output difference between the strain gauges arranged in the tires of the front wheel and the rear wheel is acquired. In case that studless tires are used or chains are attached to both of the front wheel and the rear wheel, no output difference is produced between the strain gauges. It is thus impossible to check whether the chain regulation is complied with.

It is an object of the present disclosure to provide a tire-mounted sensor and a chain regulation management system which are capable of checking whether a vehicle is in compliance with a chain regulation without visual inspection by a monitor person. It is another object of the present disclosure to provide a tire-mounted sensor and a chain regulation management system which are capable of checking whether or not a chain regulation is complied with in each wheel.

According to a chain regulation management system according to one aspect of the present disclosure comprises a tire-mounted sensor and a vehicle body side system. The tire-mounted sensor includes a vibration detection unit attached to a rear surface of a tire for outputting an output voltage corresponding to a magnitude of vibration of the tire as a detection signal, a signal processing unit for checking whether a chain is attached or not attached to the tire based on the output voltage of the vibration detection unit and generating tire state data indicating a check result, and a transmitter unit for transmitting the tire state data. The vehicle body side system includes a receiver unit for receiving the tire state data transmitted from the tire-mounted sensor, for checking whether a vehicle is in compliance with or in violation of a chain regulation based on the tire state data received by the receiver unit and transmitting a check result.

Thus, the tire-mounted sensor is provided to check whether the chain is attached or not so that a monitor person manages the chain regulation based on a check result. Therefore, even when the monitor person does not visually check the tire, it is possible to check whether or not the vehicle is in compliance with the chain regulation.

### BRIEF DESCRIPTION OF THE DRAWINGS

FIG. 1 is a view showing a block configuration of a chain regulation management system, which is in a state mounted in a vehicle, according to a first embodiment;

FIG. 2 is a block diagram of a tire-mounted sensor;

FIG. 3 is a sectional schematic view of a tire to which the tire-mounted sensor is attached;

FIG. 4 is a waveform chart showing a detection signal of an acceleration sensor;

FIG. 5A is a chart showing a change in an output voltage of the acceleration sensor in case of traveling on a high μ road surface such as an asphalt road, a road surface μ of which is comparatively high;

FIG. 5B is a chart showing a change in the output voltage of the acceleration sensor in case of traveling on a low μ road surface such as a frozen road, a road surface μ of which is comparatively low;

FIG. 6 is a chart showing a result of frequency analysis conducted on the output voltage during a ground contact period with respect to each case of traveling on the high μ road and the low μ road;

FIG. 7 is a view showing a difference in a change in the output voltage of the acceleration sensor when a chain is attached and not attached;

FIG. 8 is a flowchart showing entire processing executed by each unit of the chain regulation management system in case of identifying a vehicle in violation by exchanging information with a communication center; and

FIG. 9 is a flowchart showing entire processing executed by each unit of the chain regulation management system in case of identifying the vehicle in violation by a tool.

### EMBODIMENT FOR CARRYING OUT INVENTION

Embodiments of the present disclosure will be described below with reference to the drawings. In each embodiment described below, same or equivalent parts are designated with the same reference numerals.

### First Embodiment

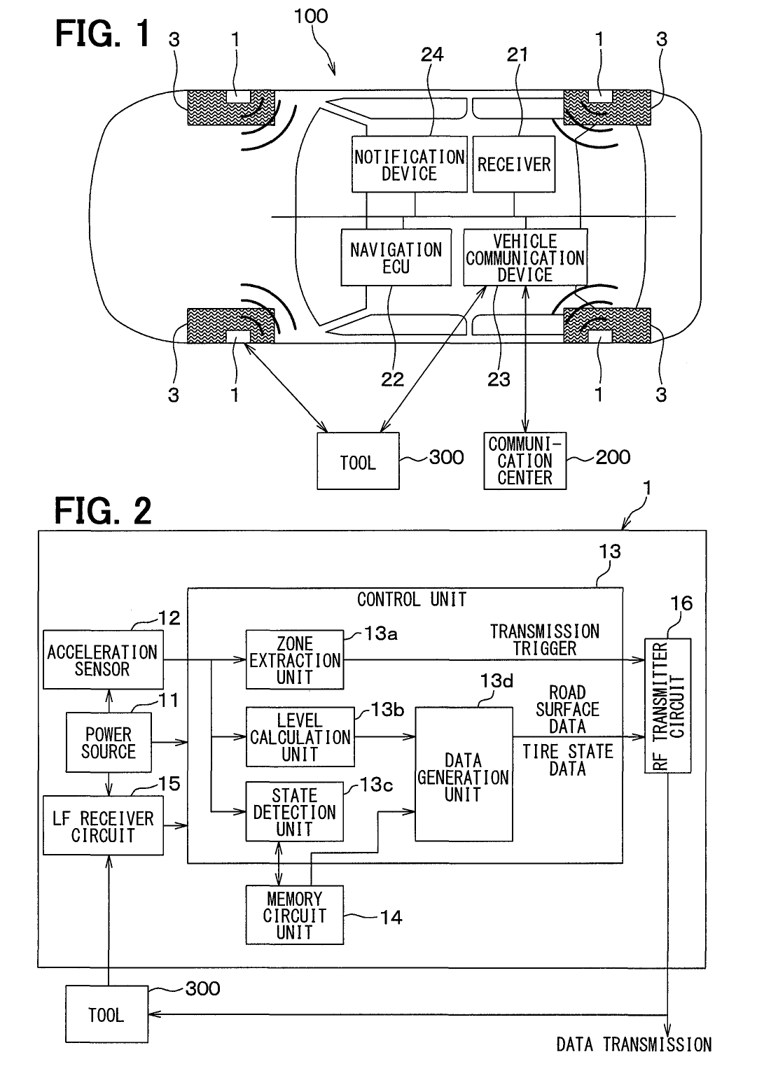

A chain regulation management system 100 according to the present embodiment, which includes a road surface state estimation device, will be described with reference to FIG. 1 to FIG. 9. The chain regulation management system 100 according to the present embodiment estimates a road surface state, on which a vehicle travels, based on vibrations applied to a ground contact zone of a tire provided on each wheel of a vehicle and further detects whether a chain is attached to a tire thereby to simplify management of a chain regulation.

As shown in FIG. 1 and FIG. 2, the chain regulation management system 100 is configured to include a tire-mounted sensor 1 mounted on a wheel side and a vehicle body side system 2 including various units mounted in a vehicle body side. As the vehicle body side system 2, a receiver 21, an electronic control unit (hereinafter referred to as a navigation ECU) 22 of a navigation device, a vehicle communication device 23, a notification device 24 and the like are provided.

In the chain regulation management system 100, the tire-mounted sensor 1 transmits data representing a road surface state during travel, such as data indicating a road surface μ between a tire 3 and the road surface on which the vehicle travels. Hereinafter, the data of the road surface μ is referred to as μ data and the data representing the road surface state such as the μ data is referred to as road surface data.

In case of the present embodiment, as shown in FIG. 2, the chain regulation management system 100 receives the road surface data transmitted from the tire-mounted sensor 1 at the receiver 21 and sends the road surface state indicated by the road surface data from the notification device 24. It is thus made possible to notify a driver of the road surface state, for example, that the road surface μ is low, a dry road, a wet road or a frozen road. It is also made possible to warn the driver if it is a slippery road surface.

In the chain regulation management system 100, the tire-mounted sensor 1 checks whether the tire 3 is in compliance with the chain regulation, that is, whether the chain is attached to the tire 3. This check result is transmitted from the tire-mounted sensor 1 to the vehicle body side system 2 as tire state data. Since the vehicle body side system 2 acquires chain regulation information through the navigation ECU 22 or the like, it is checked whether the chain regulation is complied with based on the tire state data transmitted from the tire-mounted sensor 1 when the chain regulation is issued. Here, the vehicle body side system 2 checks whether the chain regulation is complied with or violated based on the tire state data. Information on whether or not the chain regulation is complied with, for example, violation information in case of violating the chain regulation, is transmitted to the communication center 200 described later through the vehicle communication device 23. Thus, a monitor person such as a road administrator is enabled to easily identify a vehicle in violation based on the violation information transmitted to the communication center 200. In addition, by reading the tire state data from the tire-mounted sensor 1 with the tool 300, it is possible to identify that the vehicle is in violation. Hereinafter, a configuration of the chain regulation management system 100 will be described in detail.

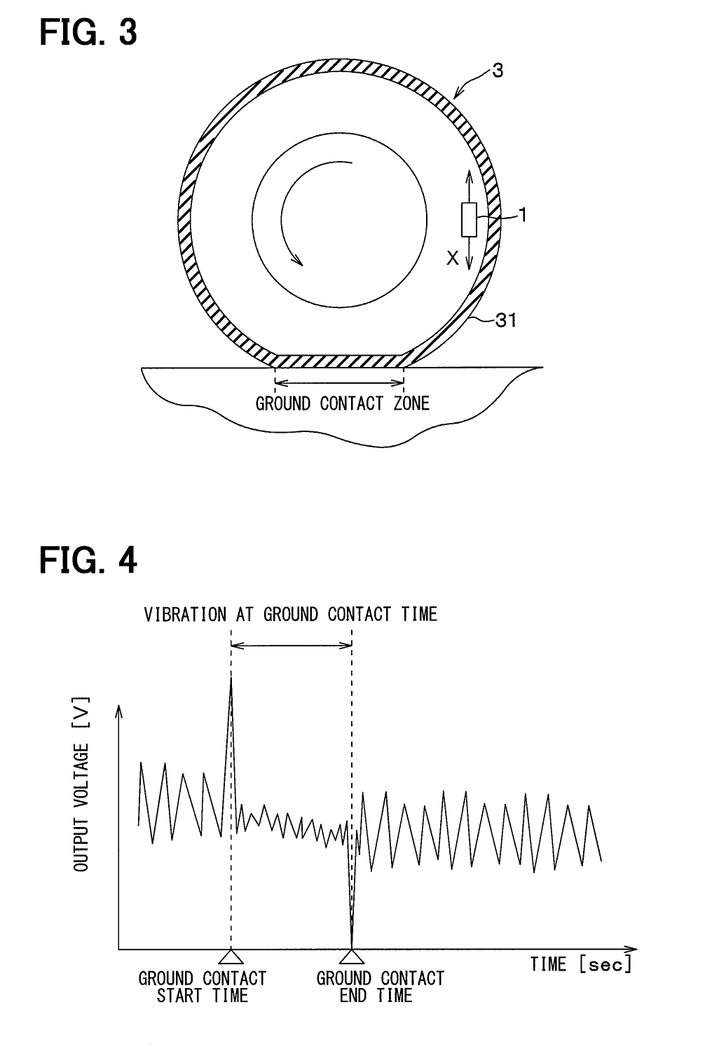

The tire-mounted sensor 1 is a tire-side device provided at each tire side. As shown in FIG. 2, the tire-mounted sensor 1 is configured to include a power source 11, an acceleration sensor 12, a control unit 13, a memory circuit unit 14, an LF receiver circuit 15 and an RF transmitter circuit 16. As shown in FIG. 3, the tire-mounted sensor 1 is provided on a rear surface side of a tread 31 of the tire 3.

The power source 11 is formed of a battery, for example, and supplies power to drive each component of the tire-mounted sensor 1.

The acceleration sensor 12 is configured as a vibration detection unit for detecting vibrations applied to a tire. For example, the acceleration sensor 12 outputs an acceleration detection signal as a detection signal corresponding to vibrations in a tire-tangential direction indicated with an arrow X in FIG. 3, that is, a direction tangential to a circular orbit which the tire-mounted sensor 1 depicts when the tire 3 rotates. For more details, the acceleration sensor 12 generates as the detection signal an output voltage, which is positive in one direction and negative in the opposite direction, between two directions indicated with the arrow X.

The control unit 13 is a signal processing unit. The control unit 13 operates to generate road surface data by using the detection signal of the acceleration sensor 12 as a detection signal, which indicates the vibration data in the tire-tangential direction, and processing this detection signal, and sends the road surface data to the RF transmitter circuit 16. Specifically, the control unit 13 extracts a ground-contact zone of the acceleration sensor 12 during rotation of the tire 3 based on the detection signal of the acceleration sensor 12, that is, a time change of the output voltage of the acceleration sensor 12. The ground-contact zone means an area of a part of the tread 31 of the tire 3, which corresponds to the location of attachment of the acceleration sensor 12 and contacting the road surface. In the present embodiment, since the location of arrangement of the acceleration sensor 12 is the location of arrangement of the tire-mounted sensor 1, the ground-contact zone is the same as the area of a portion of the tread 31 of the tire 3, which corresponds to the location of arrangement of the tire-mounted sensor 1 and is in contact with the road surface. In the following description, the location of arrangement of the tire-mounted sensor 1 in the tread 31 of the tire 3, that is, the location of arrangement of the acceleration sensor 12, is referred to as a device arrangement location.

Since high frequency components included in the detection signal of the acceleration sensor 12 generated in a period of the ground contact zone indicate the road surface state, the control unit 13 extracts the high frequency components from the detection signal and detects the road surface state such as the road surface μ based on the extracted high frequency components.

The control unit 13, thus detecting the road surface state, generates the road surface data indicating the road surface state and executes processing of sending it to the RF transmitter circuit 16. The road surface data is thus sent to the receiver 21 through the RF transmitter circuit 16. At this time, the road surface data is transmitted from the RF transmitter circuit 16 every time the tire 3 makes one rotation and hence power consumption increases. Therefore, the transmission interval may be lengthened to reduce the number of transmissions. However, if the transmission interval is simply lengthened, it is impossible to notify the change to the vehicle body side system 2 quickly when the road surface state changes. Therefore, the transmission interval may be set according to the change of the road surface state.

Further, the control unit 13 detects whether the chain is attached to the tire 3 based on the detection signal of the acceleration sensor 12. As described above, the detection signal of the acceleration sensor 12 indicates vibration data in the tangential direction of the tire. Since the vibrations applied to the tire 3 change according to the state of the ground contact surface of the tire 3, the detection signal of the acceleration sensor 12 has a waveform corresponding to the state of the ground contact surface of the tire 3. For example, in case that the chain is attached to the tire 3, a change such as an increase in the vibration of the output voltage waveform of the detection signal of the acceleration sensor 12 occurs as compared with a case where the chain is not attached. Based on this, the control unit 13 checks whether the chain is attached to the tire 3 and transmits a check result to the receiver 21.

Specifically, the control unit 13 is formed of a conventional microcomputer including a CPU, a ROM, a RAM, an I/O and the like and executes the processing described above based on a program stored in the ROM or the like. The control unit 13 includes, as functional units for executing such processing, a zone extraction unit 13a, a level calculation unit 13b, a state detection unit 13c and a data generation unit 13d.

The zone extraction unit 13a extracts the ground contact zone by detecting a peak value of the detection signal indicated by the output voltage of the acceleration sensor 12. The output voltage waveform of the acceleration sensor 12 during tire rotation changes as shown in FIG. 4, for example. As shown in this figure, at a ground contact start time at which the part corresponding to the device arrangement location starts contacting the ground during the rotation of the tire 3, the output voltage of the acceleration sensor 12 takes a maximum value. The zone extraction unit 13a detects the ground contact start time, at which the output voltage of the acceleration sensor 12 takes the maximum value, as a first peak value timing. Further, as shown in FIG. 4, at a ground contact end time at which the part of the device arrangement location ends contacting the ground during rotation of the tire 3, the output voltage of the acceleration sensor 12 takes a minimum value. The zone extraction unit 13a detects the ground contact end time at which the output voltage of the acceleration sensor 12 takes the minimum value as a second peak value timing.

The output voltage of the acceleration sensor 12 takes the peak values at the above-described timings for the following reasons. When the device arrangement location comes to contact the ground during rotation of the tire 3, the part of the tire 3 having been in generally cylindrical shape near the acceleration sensor 12 is pressed and deformed in a planar shape. Receiving an impact shock at this time, the output voltage of the acceleration sensor 12 takes the first peak value. When the part of the tire 3 corresponding to the device arrangement location leaves the ground surface during rotation of the tire 3, the part of the tire 3 is released from pressurization and restores to the generally cylindrical shape from the planar shape. Receiving the impact shock at the time of restoring the original shape of the tire 3, the output voltage of the acceleration sensor 12 takes the second peak value. As described above, the output voltage of the acceleration sensor 12 takes the first peak value and the second peak value at the ground contact start time and the ground contact end time, respectively. Since a direction of shock at the time when the tire 3 is pressed and a direction of shock at the time when the tire 3 is released from pressurization are opposite, polarities of the output voltages are also opposite.

The zone extraction unit 13a extracts the ground contact zone of the acceleration sensor 12 by extracting the data of the detection signal including the timings of the first peak value and the second peak value and sends that it is within the ground contact zone to the level calculation unit 13b.

Since the output voltage of the acceleration sensor 12 takes the second peak value at the ground contact end time of the acceleration sensor 12, the zone extraction unit 13a sends the detection signal to the RF transmitter circuit 16 at this timing. Thus the zone extraction unit 13a sends that the tire 3 made one rotation to the RF transmitter circuit 16.

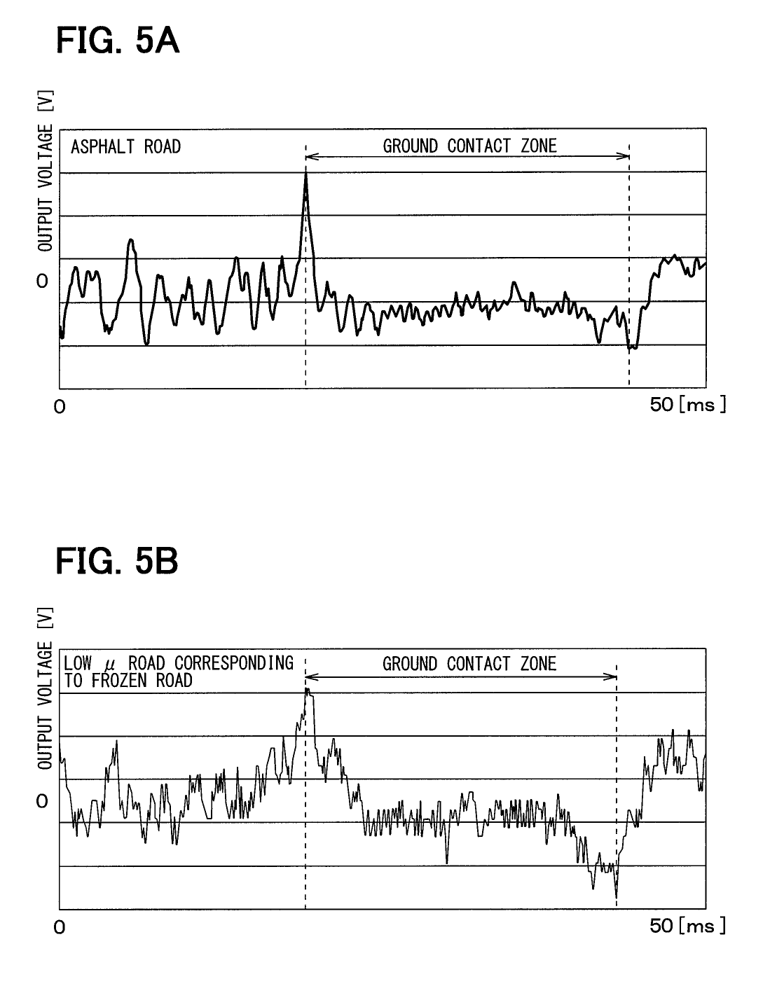

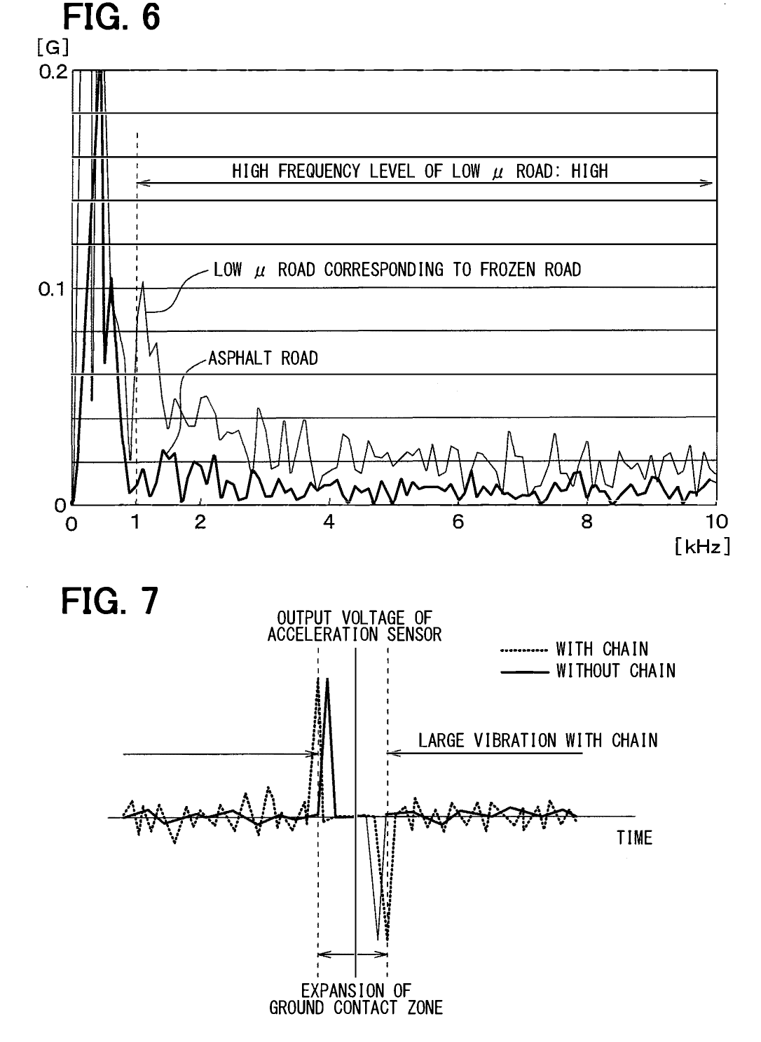

When it is sent from the control unit 13a that it is within the ground contact zone, the level calculation unit 13b calculates a level of the high frequency components, which arise from vibrations of the tire 3 and is included in the output voltage of the acceleration sensor 12 during the interval of the ground contact zone. The level calculation unit 13b sends such a calculation result to the data generation unit 13d as the road surface data such as the μ data. The level of the high frequency components is calculated as an index indicating the road surface state such as the road surface μ for the following reasons described below with reference to FIG. 5A, FIG. 5B and FIG. 6.

FIG. 5A shows a change of the output voltage of the acceleration sensor 12 in case of traveling on the high μ road surface like an asphalt road, the road surface μ of which is comparatively large. FIG. 5B shows a change of the output voltage of the acceleration sensor 12 in case of traveling on the low μ road surface like a road corresponding to a frozen road, the road surface μ of which is comparatively small.

As is evident from those figures, the first peak value and the second peak value appear at the start and the end of the ground contact zone, that is, the ground contact start time and the ground contact end time of the acceleration sensor 12, respectively, regardless of the road surface μ. However, the output voltage of the acceleration sensor 12 changes as affected by the road surface μ. For example, in case that the road surface μ is low like traveling on the low μ road surface, fine high frequency vibrations caused by slipping of the tire 3 are superimposed on the output voltage. This fine high frequency noise caused by slipping of the tire 3 is not superimposed so much in case that the road surface μ is high like traveling on the high μ road surface.

For this reason, frequency analysis of the output voltage in the ground contact zone with respect to the high road surface μ and low road surface μ produces results shown in FIG. 6. That is, in a low frequency band, the level is high regardless of traveling on the high μ road or on the low μ road. However, in a high frequency band of 1 kHz or more, the level is higher in case of the low road surface μ than in case of the high road surface μ. For this reason, the level of the high frequency components of the output voltage of the acceleration sensor 12 is the index indicating the road surface state.

Therefore, by calculating the level of the high frequency components of the output voltage of the acceleration sensor 12 in the ground contact zone by the level calculation unit 13b, it is possible to use the calculated level as the μ data. Further, it is possible to detect a type of the road surface corresponding to the road surface μ as the road surface state. For example, it is possible to determine the frozen road when the road surface μ is low.

For example, the high frequency component level is calculated as an integrated voltage value by extracting the high frequency components from the output voltage of the acceleration sensor 12 and integrating the high frequency components extracted during the interval of the ground contact zone. Specifically, the high frequency components of the frequency band fa to fb, in which it is assumed to change in correspondence to the road surface state or the road surface μ, are extracted by filtering or the like and a voltage of the high frequency components in the frequency band fa to fb extracted by the frequency analysis is integrated to acquire the integrated voltage value. For example, the high frequency components are charged in a capacitor to acquire a voltage integration value of the high frequency components. Thus the charge amount is greater in case that the road surface μ is low like traveling on the low μ road surface than in case that the road surface μ is high like traveling on the high μ road surface. By thus using the charge amount as the μ data, it is possible to estimate the road surface μ is lower as the charge amount indicated by the μ data is greater.

The state detection unit 13c detects the state of the tire 3, that is, whether the tire 3 is in compliance with the chain regulation. In the present embodiment, the state detection unit 13c detects whether the chain regulation is complied with or violated based on the tire state data. Specifically, the state detection unit 13c detects whether the chain is attached to the tire 3 based on the detection signal of the acceleration sensor 12.

The output voltage waveform of the acceleration sensor 12 changes depending on whether the chain is attached to the tire 3. For example, in case that the chain is attached to the tire 3, the vibration of the output voltage waveform of the detection signal of the acceleration sensor 12 increases as shown in FIG. 7 in comparison to a case that the chain is not attached. Particularly, in a section other than the ground contact zone, the vibration of the output voltage waveform becomes large. For this reason, by executing the frequency analysis on the output voltage waveform of the acceleration sensor 12 in the section other than the ground contact zone, it is possible to determine that the chain is attached to the tire 3 in case that, for example, the vibration level of the high frequency components exceeds a threshold value. Further, the timings of the first peak value and the second peak value deviate and the ground contact zone becomes longer when the chain is attached than when the chain is not attached. For this reason, it is possible to check whether the chain is attached to the tire 3 by calculating a rotation speed of the tire 3 from a time interval between the first peak values or between the second peak values and checking a time interval between the first peak value and the second peak value relative to the rotation speed of the tire 3. That is, by using the time interval between the first peak value and the second peak value, which is assumed in correspondence to the speed of the tire 3 without chain as a threshold value, it is determined that the chain is attached to the tire 3 when the measured time interval between the first peak value and the second peak value exceeds the threshold value.

Further, after checking whether the chain is attached to the tire 3 as described above, the state detection unit 13c sends the check result to the data generation unit 13d.

The data generation unit 13d basically generates the road surface data based on the calculation result of the level calculation unit 13b. For example, the data generation unit 13d uses the μ data as it is as the road surface data or generates data as the road surface data by determining the road surface state like the frozen road or the asphalt road based on the μ data. In addition, the data generation unit 13d generates data as to whether or not the chain is attached to the tire 3 based on the detection result of the state detection unit 13c as the tire state data. The road surface data and the tire state data generated by the data generating unit 13d are sent to the RF transmitter circuit 16 simultaneously or separately. The tire state data is also sent to the memory circuit unit 14.

The memory circuit unit 14 is a memory unit, which executes storing, reading out and erasing of data in response to instructions from the control unit 13. For example, upon receiving the tire state data from the control unit 13, the memory circuit unit 14 stores such information. Further, the memory circuit unit 14 reads out the stored tire state data and sends it to the control unit 13 upon receiving a command of read-out of the tire state data from the control unit 13.

The LF receiver circuit 15 is a receiver unit which receives a command input through a tool 300 or the like. For example, when an LF wave including the instruction command of the monitor person in charge of the chain regulation is transmitted to the tire-mounted sensor 1, the instruction command is transmitted to the control unit 13 through the LF receiver circuit 15. The control unit 13 is configured to output the read-out command for reading out the tire state data stored in the memory circuit unit 14 so that the tire state data is read out from the memory circuit unit 14. The tire state data at this time is stored at the time of vehicle traveling. Since the tire state data is still stored even while the vehicle is stopped, it is possible to read it out from the memory circuit unit 14 even while the vehicle is stopped.

The RF transmitter circuit 16 forms a transmission unit, which transmits to the receiver 21 and the tool 300 the road surface data such as the μ data and the tire state data sent from the data generation unit 13d. The communication between the RF transmitter circuit 16 and the receiver 21 or the tool 300 may be executed by conventional short-range radio communication technology like Bluetooth (registered trademark).

Although the road surface data may be transmitted at arbitrary timing, the road surface data and the tire state data are transmitted from the RF transmitter circuit 16 in the present embodiment in response to a transmission trigger sent from the zone extraction unit 13a at the ground contact end time of the acceleration sensor 12. It is thus possible to reduce power consumption by executing the data transmission by the RF transmitter circuit 16 not continuously but limitedly at the ground contact end time of the acceleration sensor 12. Further, when the instruction command is received from the tool 300, the RF transmitter circuit 16 transmits the tire state data so as to respond to such an instruction command. As a result, it is possible to transmit the tire state data to the tool 300.

The road surface data and the tire state data are sent with individual identification information (hereinafter referred to as ID information) provided for each tire 3 of a road wheel of the vehicle. The position of each wheel is specified by a conventional wheel position detection device which detects to which position of the vehicle the wheel is attached. Thus it is possible to determine to which wheel the data belongs by sending the road surface data and the tire state data together with the ID information to the receiver 21.

It is assumed here that the tire state data is transmitted together with the road surface data from the RF transmitter circuit 16. It is also possible to alternatively store those data in different frames and transmit at different timings.

The receiver 21 receives the road surface data transmitted from the tire-mounted sensor 1, estimates the road surface state based on the received road surface data, sends the estimated road surface state to the notification device 24 and conveys, if necessary, the road surface state to a driver from the notification device 24. Thus, the driver tries to drive the vehicle in a manner matching the road surface state and is enabled to avoid danger to the vehicle. For example, the estimated road surface state may be displayed always by the notification device 24 or the road surface state may be displayed to warn the driver only when the vehicle need be driven more carefully than usual, for example, when the estimated road surface state corresponds to the low μ road like the wet road or the frozen road.

In addition, the receiver 21 receives the tire state data transmitted from the tire-mounted sensor 1 and recognizes whether the chain is attached to the tire 3 or not. The receiver 21 further acquires the chain regulation information through the navigation ECU 22 or the vehicle communication device 23. In case that the chain regulation is enforced, the receiver 21 checks the state of the tire 3 indicated by the tire state data. The receiver 21 then transmits information indicating whether the chain is attached, that is, the chain regulation is complied with, to the communication center 200 through the vehicle communication device 23. In case that the chain is attached, the receiver 21 does not take any action because the vehicle is in compliance with the chain regulation. In case that the chain is not attached, the receiver 21 transmits data indicating that the chain regulation is not complied with as violation information because the vehicle is not in compliance with the chain regulation. For example, the receiver 21 transmits the data indicating non-compliance with the chain regulation together with the ID information of the vehicle itself to the communication center 200. It is thus possible to send the information about the vehicle, which is in violation of the chain regulation, to the communication center 200.

The navigation ECU 22 is provided in the navigation system and executes processing of information acquisition from a non-transitional physical storage medium such as a memory that stores road information and the like and processing of measurement of the present position of the vehicle based on position information of a GPS (global positioning system) satellite, for example. Then, the navigation ECU 22 executes various processing relating to route guidance etc. based on the road information and the measured present position. Further, the navigation ECU 22 acquires traffic information by road-to-vehicle communication or the like and, in case of executing the route guidance or the like, provides the guidance in consideration of the traffic information. Since the traffic information acquired by the navigation ECU 22 includes the chain regulation information, the chain regulation information is sent to the receiver 21.

Although the navigation ECU 22 is exemplified as a device for acquiring the chain regulation information, any devices other than the navigation ECU 22 may be used. For example, the chain regulation information may be acquired through a portable device such as a cellular phone, which is configured to be able to exchange information with each unit of the vehicle body side system 2. Further, the chain regulation information may be acquired from the communication center 200 or the like through the vehicle communication device 23.

The vehicle communication device 23 is configured to be able to execute the road-vehicle communication to exchange information with the communication center 200 via a communication system (not shown) installed on a road or the like, for example. In the present embodiment, the vehicle communication device 23 transmits the information as to whether or not the vehicle is in compliance with the chain regulation sent from the receiver 21, that is, the information indicating whether the chain regulation is complied with, to the communication center 200.

The notification device 24 is configured with a meter display device for example and used to notify the driver of the road surface state. In case that the notification device 24 is configured with the meter display device, it is located at a position which the driver is capable of recognition during driving of the vehicle, for example, within an instrument panel in the vehicle 1. The meter display device notifies the driver visually of the road surface state in a display mode enabling recognition of the road surface state and the compliance or non-compliance with the chain regulation, when the road surface state and the compliance or non-compliance with the chain regulation are sent from the receiver 21.

The notification device 24 may alternatively be configured with a buzzer or a voice guidance device. In such a case, the notification device 24 notifies the driver of the information audibly by buzzer sound or voice guidance. Although the meter display device is exemplarily referred to as the notification device 24 for providing visual notification, the notification device 24 may be configured with a display device like a head-up display which provides information display.

The chain regulation management system 100 according to the present embodiment is configured as described above. Each unit forming the vehicle body side system 2 is connected through an in-vehicle LAN (Local Area Network) like CAN (Controller Area Network) communication. Thus each unit is capable of communicating information mutually through the in-vehicle LAN.

On the other hand, the communication center 200, which exchanges information with the chain regulation management system 100, collects road information, provides vehicles with road information and traffic information, for example, chain regulation information, and runs business of such as management and administration of the chain regulation. The communication center 200 and the vehicle communication device 23 may be configured to be able to communicate directly. The communication center 200 is configured to communicate with the vehicle communication device 23 through communication systems located at various points such as roads.

The communication center 200 manages the database of information about compliance with the chain regulation transmitted from the vehicle communication device 23 of each vehicle and checks whether the vehicle is in compliance with the chain regulation based on the received information. In the present embodiment, the communication center 200 manages a database of information of the vehicle in violation, which is transmitted from the vehicle communication device 23 of each vehicle and indicates that the vehicle is in violation of the chain regulation, and determines the vehicle in violation based on the received information of the vehicle in violation. For example, the monitor person is enabled to check whether the vehicle is in compliance with the chain regulation by accessing the database of the communication center 200 with the tool 300, which may be a device capable of communication with the vehicle communication device 23 or a device capable of inputting a license plate number attached to the vehicle. As in the present embodiment, in case that the information of the vehicle in violation is managed by the database of the communication center 200, it is possible to check whether the vehicle is in violation by accessing to the database. Thereby, even in case the management person does not visually recognize the tire 3, it is possible to identify the vehicle in violation even from a remote place.

In addition, since there are some on-road systems which are capable of communication with the vehicle communication device 23 and reading the license plate number. By using this kind of the on-road system, it is possible to check whether the vehicle is in compliance or not, for example, identify the vehicle in violation. Likewise, in a place such as an entrance gate of a toll road, where there is a system capable of communication with the vehicle communication device 23 or capable of reading the license plate number, it is possible to check whether the vehicle is in compliance or not, for example, identify the vehicle in violation before the vehicle enters the toll road. Thus it is possible to identify the vehicle in violation without visually checking the tire 3 by the monitor person and restrict the vehicle in violation from entering the toll road.

Furthermore, it is also possible to read out the tire state data from the tire-mounted sensor 1 using the tool 300 and check whether the vehicle is in compliance or not, for example, determination that the vehicle is in violation. In the present embodiment, as described above, since it is stored as tire state data in the memory circuit unit 14 whether the chain regulation is complied with or not, the tire state data is read out from the tire-mounted sensor 1 by outputting the LF wave including the instruction command from the tool 300. The tire state data is transmitted from the RF transmitter circuit 16 and received by the tool 300. This makes it possible to check whether or not the vehicle is in violation based on the information indicated by the tire state data as to whether the tire 3 is in compliance with or in violation of the chain regulation. In this case, since it is only necessary to receive the information from the tire-mounted sensor 1, it is possible to check whether or not the vehicle is in compliance with the regulation even when the vehicle 1 is stopped, for example, the ignition switch is in the off-state.

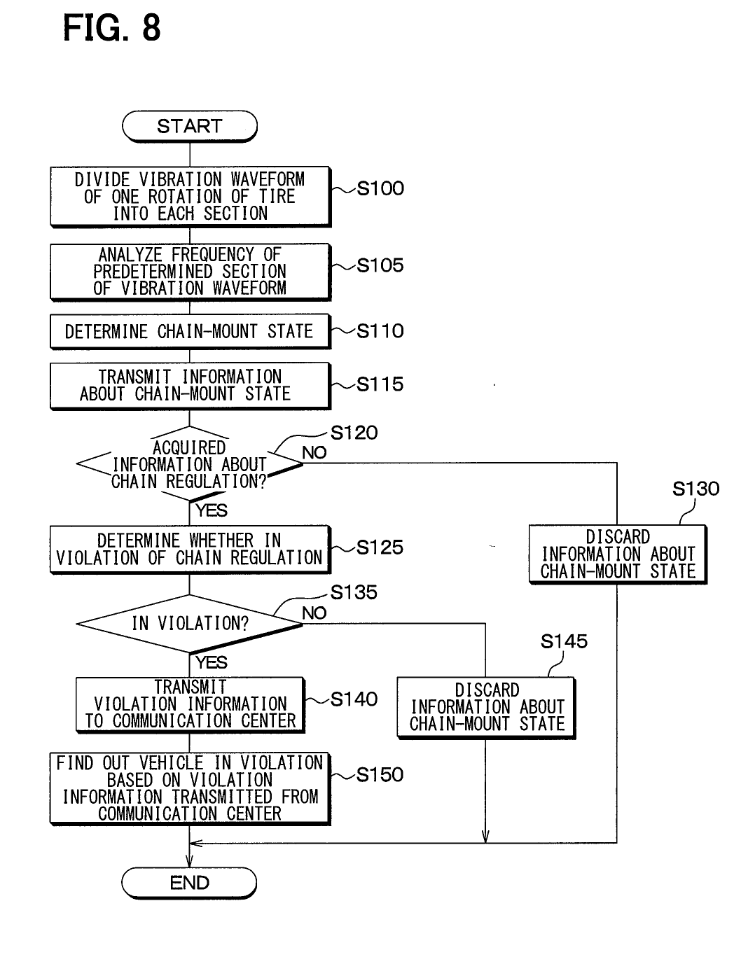

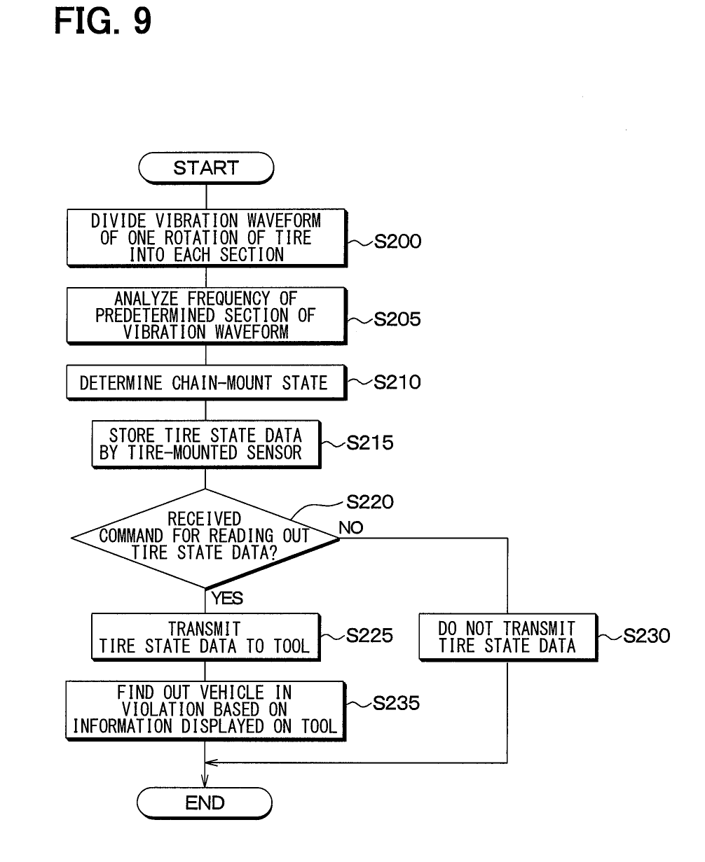

An operation of the chain regulation management system 100 according to the present embodiment will be described next. In the chain regulation management system 100, the units which function as the road surface state detection device receives the road surface data transmitted from the tire-mounted sensor 1 by the receiver 21 and operates to convey the road surface data to the driver through the notification device 24 when necessary. The chain regulation management system 100 manages the chain regulation as described below. A method of the chain regulation management will be described with reference to FIG. 8 and FIG. 9. Regarding the chain regulation management in the present embodiment, checking whether the chain regulation is complied with, that is, identification of the vehicle in violation of the chain regulation, is executed by the communication center 200 in some cases and by the tool 300 in another case. Therefore, each of these cases will be described.

First, with reference to FIG. 8, a description will be given of a case where the communication center 200 identifies the vehicle in violation which is not in compliance with the chain regulation.

In the tire-mounted sensor 1, the control unit 13 executes respective processing of steps S100 to S115.

Specifically, as described in step S100, the vibration waveform of the output voltage of the acceleration sensor 12 produced during one rotation of the tire 3 is acquired and the vibration waveform is divided into each section. For example, it is divided into a section before the first peak value, a section from which the first peak value is extracted, a section from the first peak value to the second peak value, a section from which the second peak value is extracted and a section after the second peak value. Subsequently, in step S105, sections other than the ground contact zone, for example, the section before the first peak value or the section after the second peak value, are selected from the sections divided in step S100, and the vibrations of the output voltage of the acceleration sensor 12 in such sections are frequency-analyzed.

Then, in step S110, based on the result of the frequency analysis in step S105, it is checked whether the chain is attached or not. In other words, as shown in FIG. 7, the vibrations of the output voltage waveform of the acceleration sensor 12 in the sections other than the ground contact zone vary between cases whether the chain is attached or not attached. Therefore, by executing the frequency analysis on the output voltage waveform of the acceleration sensor 12 in the sections other than the ground contact zone, it is possible to check whether the chain is attached or not.

After checking whether the chain is attached or not attached as described above, the check result is transmitted to the vehicle body side system 2 in step S115.

Thereafter, in the vehicle body side system 2, a control unit built in the receiver 21 executes processing in steps S120 to S145.

More specifically, in step S120, it is checked whether or not the chain regulation information has been acquired in the vehicle body side system 2. Here, an affirmative determination and a negative determination are made if the navigation ECU 22 or the vehicle communication device 23 has acquired and has not acquired the chain regulation information, respectively. If the affirmative determination is made in step S120, step S125 is executed to check whether the chain regulation is complied with or not based on the information received from the tire-mounted sensor 1 in the vehicle body side system 2 on whether the chain is attached or not. On the other hand, if the negative determination is made in step S120, step S130 is executed to discard the data transmitted from the tire-mounted-sensor 1 and indicating whether the chain is attached or not thereby finishing this processing.

After execution of step S125, step S135 is executed to check whether the chain regulation is violated or not based on the check result of step S125. Here, in case that the chain is not attached, an affirmative determination is made and step S140 is executed to transmit to the communication center 200 via the vehicle communication device 23 that the vehicle is not in compliance with and in violation of the chain regulation. On the other hand, in case that the chain is attached, a negative determination is made and step S145 is executed to execute the same processing as step S130.

Then, in response to the processing of step S140, as shown in step S150, the monitor person of the chain regulation is enabled to identify the vehicle in violation based on such information related to the vehicle in violation as received from the communication center 200. For example, it is possible to identify the vehicle in violation at the entrance of the toll road by using an on-road system and the like so that the administrator of the entrance of the toll road restricts the vehicle in violation of the chain regulation from entering the toll road as the monitor person of the chain regulation.

Next, with reference to FIG. 9, a description will be given of a case where the vehicle, which is in violation of and is not in compliance with the chain regulation, is identified by using the tool 300.

In the tire-mounted sensor 1, the control unit 13 executes the same processing as that of steps S100 to S110 shown in FIG. 8 as each processing shown in steps S200 to S210. Then processing of step S215 is executed. Specifically, based on a check result in step S210, the tire state data indicating that the chain is attached in compliance with the chain regulation or the chain is not attached in violation of the chain regulation is stored in the memory circuit unit 14. The tire state data may be stored in the memory circuit unit 14 at every rotation of the tire 3. It should be noted however that attachment and non-attachment of the chain to the tire 3 does not change at every rotation. Therefore, it is sufficient to store the tire state data in the memory circuit unit 14 thereby updating the past stored data each time the tire 3 makes a plurality of rotations, for example, every ten rotations or when the tire 3 starts rotation again after stopping once.

Thereafter, in the tire-mounted sensor 1, the control unit 13 executes respective processing of steps S220 to S230. In step S220, it is checked whether or not the instruction command for reading out the tire state data is received from the tool 300. In case that the monitor person of the chain regulation issues the instruction command through the tool 300, an affirmative determination is made in this step. In case that the instruction command is not issued, a negative determination is made in this step.

In case that the affirmative determination is made in step S220 indicating the issuance of the instruction command from the tool 300, step S225 is executed so that the data relating to whether the chain is attached or not attached is transmitted to the tool 300. In case that the negative determination is made in step S220, step S230 is executed since the instruction command from the tool 300 has not been issued. In step S230, no tire state data concerning whether the chain is attached or not is transmitted thereby finishing this processing.

Then, in response to the processing of step S225, the data indicating whether the chain is attached or not is transmitted to the tool 300. Therefore, as shown in step S235, the monitor person of the chain regulation is enabled to instantly determine whether the vehicle receiving the instruction command from the tool 300 is in compliance with or in violation of the chain regulation.

As described above, the chain regulation management system 100 according to the present embodiment checks by the tire-mounted sensor 1 whether the chain is attached or not. Based on this check result, the monitor person manages the chain regulation. Specifically, by notifying the communication center 200 of the data indicating that the vehicle is in violation of the chain regulation, the monitor person is enabled to easily find out the vehicle in violation based on the violation information which is communicated to the communication center 200. In addition, whether the chain regulation is complied with or violated is stored in the memory circuit unit 14 of the tire-mounted sensor 1 as the tire state data. For this reason, it is possible for the monitor person to confirm whether the vehicle is in violation or not by simply referring to the tool 300, when the monitor person transmits the instruction command by using the tool 300 so that the tire state data is transmitted from the tire-mounted sensor 1 to the tool 300.

Therefore, even when the monitor person does not visually check the tire 3, it is possible to check whether or not the vehicle is in compliance with the chain regulation. In addition, it is further possible to check whether or not the vehicle is in compliance with the chain regulation by each tire-mounted sensor 1. Therefore, it is also possible to check whether or not the vehicle is in compliance with the chain regulation with respect to each road wheel.

### Second Embodiment

A second embodiment will be described. The present embodiment is configured to check further whether the tire is a studless tire relative to the first embodiment. Since other configuration is the same as the first embodiment, only differences from the first embodiment will be described.

In the embodiment described above, it is checked whether the chain is attached or not based on the detection signal of the acceleration sensor 12 of the tire-mounted sensor 1. On the other hand, in the present embodiment, it is also checked whether or not the tire 3 is a studless tire.

Vehicles which are in compliance with the chain regulation include not only chain-attached vehicles but also studless tire-equipped vehicles. Whether or not the tire 3 is a studless tire is known in advance. Therefore, a type of the tire 3 is stored in the memory circuit unit 14 in advance as the tire state data at time of attaching the tire-mounted sensor 1 to the tire 3. It is thus possible to check whether the tire 3 is the studless tire or a radial tire based on the stored tire state data. For example, by registering individual ID information specific to each tire 3 as tire information data in the memory circuit unit 14, it is possible to grasp the tire type as to whether the tire 3 is the studless tire or the radial tire based on the stored ID information. Of course, it is also possible to store data directly indicating the tire type, that is, studless tire or radial tire, in the memory circuit unit 14.

Then, for example, in case of transmitting the result of determination as to whether the chain is attached or not to the vehicle body side system 2 as shown in step S115 of FIG. 8, data indicating whether the tire 3 is a studless tire or the radial tire is also transmitted as the tire information data. Then, when checking whether or not the chain regulation is violated in step S135, it is determined that the vehicle is not in violation of the chain regulation when not only the chain is attached but also when the tire 3 is a studless tire.

Similarly, for example, when transmitting the tire state data in step S230 in FIG. 9, data indicating not only whether the tire 3 is attached but also whether the tire 3 is a studless tire or a radial tire are transmitted.

This makes it possible to determine the vehicle is in violation of the chain regulation in case that the chain is not attached and the tire 3 is not a studless tire and manage the chain regulation more accurately in the communication center 200. In addition, the same determination can be made when the monitor person uses the tool 300 to monitor a vehicle in violation.

Here, as shown in the flowcharts shown in FIG. 8 and FIG. 9, the tire state data is transmitted from the tire-mounted sensor 1 for each rotation of the tire 3. That is, the type of the tire 3 is also transmitted at every rotation of the tire 3. In case of exchanging tires, it is likely that a tire with a chain and a tire without a chain are exchanged even in case that the types of the tires are the same. For this reason, it is effective to transmit the tire state data at every rotation of the tire 3. However, with regard to the type of tire, it will not change unless a tire exchange or the like is made. For this reason, with regard to the type of the tire 3, it is sufficient to be transmitted to the vehicle body side system 2 when the tire-mounted sensor 1 is attached to the tire 3. It is not necessary to transmit it at every rotation of the tire 3.

Here, it is detected whether the chain is attached and a check result is transmitted as the tire information data in addition to the type of tire whether the tire 3 is a studless tire or a radial tire, However, it is also possible to transmit only the tire type as the tire information data.

### Other Embodiment

Although the present disclosure is made based on the embodiments described above, the present disclosure is not limited to such embodiments but includes various changes and modifications which are within equivalent ranges. Furthermore, various combinations and formations, and other combinations and formations including one or more than one or less than one element may be included in the scope and the spirit of the present disclosure.

For example, in the embodiments described above, the ground contact zone is specified from the detection signal of the acceleration sensor 12 forming the vibration detection unit and the calculation result of the level of the high frequency components in the detection signal in the ground contact zone is used as the road surface data. However, this is only one example of a method of estimating the road surface state using the detection signal of the vibration detection unit. The road surface state may be estimated by any other methods which use the detection signal of the vibration detection unit. Although the vibration detection unit is formed exemplarily of the acceleration sensor 12, the vibration detection unit may be configured by any other vibration detection elements, for example, a piezoelectric element or the like. In addition, the power source 11 is not limited to a battery but may be configured of a power generating element or the like. For example, in case of a vibration detection element, it may be used to form not only the vibration detection unit but also the power source 11.

Further, in the embodiments described above, the receiver 21 is provided to function as the control unit for executing checking whether the road surface state has changed based on the road surface data and whether the vehicle is in compliance with the chain regulation. However, this is only one example. This control unit may be provided separately from the receiver 21 or provided as another ECU such as the navigation ECU 22.

In the embodiments described above, the violation information is transmitted to the communication center 200 when the vehicle is in violation. On the contrary, when the vehicle is in compliance with the chain regulation, the compliance information indicating compliance with the regulation may be transmitted to the communication center 200. In that case, the compliance vehicle information about vehicles in compliance with the chain regulation is managed in the database of the communication center 200. Therefore, in case of checking whether the chain regulation is complied with or violated by using the tool 300, it is determined that the vehicle is in compliance with and in violation of the regulation when the vehicle is managed and not managed in the database, respectively. Of course, it is possible to transmit information on both of the vehicles which are in compliance and in violation to the communication center 200 so that both vehicles may be grasped.

Further, in the embodiments described above, as one method for restricting the vehicle in violation of the chain regulation from traveling on a road, to which the chain regulation is enforced, it is exemplified that such a vehicle in violation is restricted from entering the toll road when it is determined at the entrance of the toll road that the vehicle is in violation. In addition, it is also possible to audibly warn the driver that your vehicle is not permitted to travel indicating non-compliance with the chain regulation by using an alarm function of the road system. In addition, in case that the navigation ECU 22 provides an area of the chain regulation, it is possible to notify by a warning alarm of the notification device 24 and the like that the chain regulation is not complied with, for example, before entering the regulated area or in the regulated area. Similarly, it is also possible to notify the vehicle body side system 2 from the communication center 200 through the vehicle communication device 23 that the vehicle approaches the chain regulation area and notify that the chain regulation is not complied with by the notification device 24.

Further, in the embodiments described above, the form of the tool 300 used by the observer is not limited. That is, the tool is not limited to equipment that can be used by the monitor person but may be other devices such as a device fixed to a road and the like.

Furthermore, in the second embodiment, the type of the tire 3 is grasped by registering the individual ID information of the tire 3 in advance. On the other hand, by checking whether the tire 3 is a studless tire or a radial tire based on the output voltage waveform of the vibration detection unit and storing the check result in the memory circuit unit 14, the type of the tire 3 may be grasped.

For example, in case of a studless tire, as compared with a radial tire, unevenness formed on the tread 31 is and rubber of the tire 3 is also soft, so that an attenuation factor of the vibration is large and the vibration of the output voltage waveform of the acceleration sensor 12 is small. Therefore, based on the magnitude of the vibration of the output voltage waveform of the acceleration sensor 12, it is possible to determine whether the tire 3 is a studless tire or a radial tire.

As for the vibration of the output voltage waveform of the acceleration sensor 12, it varies with the vehicle speed as far as the vehicle travels on a predetermined road surface. It is therefore preferred to set threshold values for determining the type of the tire 3 in correspondence to the vehicle travel speed. Since the interval between the first peak values or the interval between the second peak values of the output voltage waveform of the acceleration sensor 12 is the time taken for one rotation of the tire 3, the vehicle travel speed is calculated based on the interval. Therefore, it is preferable to calculate the change in the vehicle travel speed from the output voltage waveform of the acceleration sensor 12 and set the threshold values according to the calculated vehicle travel speed for use in determining the type of the tire 3.

In each of the embodiments described above, as the chain regulation management system capable of confirming compliance with the chain regulation, it is exemplified to further determine whether the vehicle is in compliance with or in violation of the regulation. However, it is not necessary to determine that the vehicle is in violation and it is sufficient to determine whether the vehicle is in compliance. For example, with respect to the tire-mounted sensor 1, it is sufficient to store and transmit the information indicating whether the vehicle is in compliance with the chain regulation. The receiver 21 may be of any type as far as it determines whether or not the vehicle is in compliance with the chain regulation based on the information indicating compliance with the chain regulation. Further, the vehicle communication device 23 may be any device that transmits information usable to check whether or not the vehicle is in compliance with the chain regulation. Similarly, the communication center 200 may be any device that manages and provides information about the compliance with the chain regulation.

In the embodiments described above, the check result relating to whether the chain regulation is complied with is transmitted to the receiver 21 or the tool 300. This transmitted check result is sent to the monitor person of the chain regulation through the tool 300 or to the communication center 200 through the vehicle communication device 23. However, this is also one example of using the transmitted check result. The check result indicating whether the chain regulation is complied with may be used in vehicle motion control. That is, stability of the vehicle changes when the vehicle travels on a snowy road and the like depending on whether the vehicle is in compliance with the chain regulation. For this reason, for example, in setting a threshold value of the vehicle motion control such as a threshold value of control intervention in anti-lock brake control or anti-skid control, the check result as to whether the vehicle is in compliance with the chain regulation is complied with may be used.

Besides the types of tires 3 includes not only a radial tire and a studless tire but also an all-season tire. Characteristically, the all-season tire is categorized to be in between the radial tire and the studless tire. It is possible to travel on a slightly snow-covered road and the like with the all-season tire. For this reason, whether or not the all-season tire is categorized to be a tire which is in compliance with the chain regulation depends on a country, area and the like. For this reason, the all-season tire may be categorized as a studless tire in case that it is treated as a tire which complies with the chain regulation and categorized as a radial tire in case that it is not treated as a tire which complies with the chain regulation.

What is claimed is:

1. A chain regulation management system comprising:
a tire-mounted sensor including a vibration detection unit attached to a rear surface of a tire for outputting an output voltage corresponding to a magnitude of vibration of the tire as a detection signal, a signal processing unit for checking whether a chain is attached or not attached to the tire based on the output voltage of the vibration detection unit and generating tire state data indicating a check result, and a transmitter unit for transmitting the tire state data; and
a vehicle body side system including a receiver unit for receiving the tire state data transmitted from the tire-mounted sensor, checking whether a vehicle is in compliance with or in violation of a chain regulation based on the tire state data received by the receiver unit and transmitting a check result.

2. The chain regulation management system according to claim 1, wherein:
the vehicle body side system checks whether the vehicle is in compliance with or in violation of the chain regulation based on compliance information managed in a database of a communication center, which manages information to be used to check whether the vehicle is in compliance with the chain regulation in correspondence to the check result of the vehicle body side system.

3. The chain regulation management system according to claim 1, wherein:
the vehicle body side system checks whether the vehicle is in compliance with or in violation of the chain regulation based on the tire state data and transmits the check result.

4. The chain regulation management system according to claim 3, wherein:
the vehicle body side system checks, whether the vehicle is in compliance with or in violation of the chain regulation based on at least one of compliance information and violation information indicating that the vehicle is in compliance with and in violation of the chain regulation managed in a database of a communication center, which manages information of the at least one of the compliance information and the violation information to be used to check whether the vehicle is in compliance with or in violation of the chain regulation based on the check result in correspondence to the check result of the vehicle body side system.

5. The chain regulation management system according to claim 1, wherein:
the tire-mounted sensor includes a memory unit for storing the tire state data; and
the signal processing unit reads out the tire state data stored in the memory unit and transmits the tire state data from the transmitter unit in response to an instruction command.

6. The chain regulation management system according to claim 5, wherein:
when the instruction command is inputted to the tire-mounted sensor from a tool, the signal processing unit reads out the tire state data stored in the memory unit and transmits the tire state data from the transmitter unit to the tool.

7. The chain regulation management system according to claim 1, further comprising:
a memory unit for further storing, as the tire state data, information about a tire type indicating whether the tire is a studless tire or a radial tire,
wherein the tire-mounted sensor transmits, as the tire state data, the information about the tire type to the vehicle body side system.

8. A tire-mounted sensor comprising:
a vibration detection unit attached to a rear surface of a tire for outputting an output voltage corresponding to a magnitude of vibration of the tire as a detection signal;
a signal processing unit for checking whether a chain is attached or not attached to the tire based on the output voltage of the vibration detection unit and generating tire state data indicating a check result; and
a transmission unit for transmitting the tire state data.

9. The tire-mounted sensor according to claim 8, further comprising:
a memory unit for storing the tire state data,
wherein, when an instruction command is inputted to the tire-mounted sensor from a tool, the signal processing unit reads out the tire state data stored in the memory unit and transmits the tire state data from the transmitter unit.

10. The tire-mounted sensor according to claim 9, wherein:
the memory unit further stores, as the tire state data, information about a tire type indicating whether the tire is a studless tire or a radial tire.

11. (canceled)

12. (canceled)
